(19) United States
(12) Patent Application Publication
(10) Pub. No.: US 2024/0100951 A1
(43) Pub. Date: Mar. 28, 2024

(54) DRIVING EMULATION APPARATUS

(71) Applicant: PARADIGMA S.R.L., Padova (IT)

(72) Inventor: Antonio Guadagnino, VIa Modigliani (IT)

(73) Assignee: PARADIGMA S.R.L., Padova (IT)

(21) Appl. No.: 18/255,135

(22) PCT Filed: Aug. 13, 2021
(86) PCT No.: PCT/IB2021/057471

§ 371 Date: May 31, 2023

(30) Foreign Application Priority Data
Dec. 2, 2020 (IT) 102020000029501

(51) Int. Cl. B60K 37/06; B60K 35/00

(52) U.S. Cl. CPC B60K 37/06; B60K 35/00; B60K 2370/152; B60K 2370/167; B60K 2370/176; B60K 2370/21; B60K 2370/52; B60K 2370/589

(57) ABSTRACT

An emulation apparatus (1) for driving a vehicle (5) driven by a driver and having control device (50), the emulation apparatus (1) including shooting device (20) to film the vehicle driver's view (5) and generate a shooting output, sensor device (21) to check the instantaneous vehicle's conditions (5) and generate a condition output, a control apparatus (22) having transmission device (23) to receive the shooting output and the condition output, at least one emulation device (3) to connect to the control apparatus (22) and including: display device (30) of the shooting output, control device (31) to emulate the vehicle control device (50) to allow a practitioner to emulate the vehicle driving (5), the control device (31) generating a practicing command output, the control apparatus (22) comparing the vehicle condition output (5) with the practicing command output and displaying on the display device (30) a comparison between said outputs.

### CROSS REFERENCE TO RELATED APPLICATION

This application is a national stage entry of PCT/IB2021/057471 filed Aug. 13, 2021, under the International Convention claiming priority over Italian Patent Application No. 102020000029501 filed Dec. 2, 2020.

### FIELD OF THE INVENTION

The present invention relates to an emulation apparatus for driving, for example for driving aircraft, cars and similar, of the type specified in the preamble of the first claim.

### BACKGROUND OF THE INVENTION

It is currently known the emulation and simulation systems for driving.

For example, the simulators make it possible to learn or improve the driving of aircraft and cars, without entailing the associated risks, in particular for the people driving and for the people around them.

Said simulators are more and more precise and therefore simulate real driving in an ever more realistic way.

For example, the so-called “Full Flight Simulators” (FFS) are known, which allow to replicate an operational scenario, in a civil or military context, in a complete manner, thus allowing crews to train.

The known art described includes some important drawbacks.

In particular, the simulators, however precise, will never be able to perfectly emulate the real exercises and practices.

Furthermore, said simulators are very expensive and complex.

In some cases, the problem was solved with emulations. During the emulations, practitioners are asked to imitate the gestures of more experienced drivers.

However, even the latter have important limitations.

In this situation, the technical task underlying the present invention is to devise a driving emulation apparatus capable of substantially obviating at least part of the aforementioned drawbacks.

### SUMMARY OF THE INVENTION

Within the scope of said technical task, it is an important object of the invention to obtain a driving emulation apparatus that allows practitioners to interface as much as possible with the reality.

Another important object of the invention is to realize an emulation apparatus for driving that is simple and cheap.

The technical task and the specified aims are achieved by an emulation apparatus for driving as claimed.

### BRIEF DESCRIPTION OF THE DRAWINGS

The characteristics and advantages of the invention are clarified below by the detailed description of preferred embodiments of the invention, with reference to the accompanying figures, in which:

FIG. 1 shows an emulation apparatus for driving according to the invention.

### DETAILED DESCRIPTION OF THE INVENTION

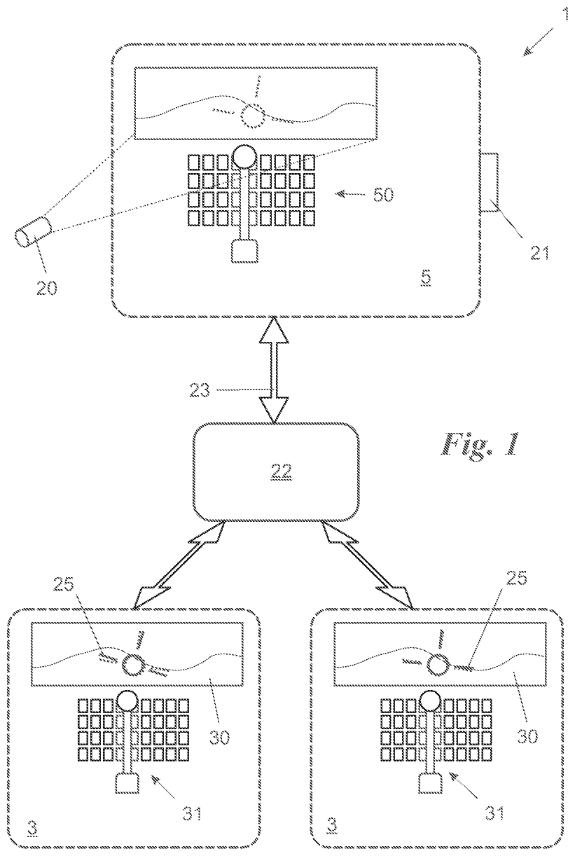

FIG. 1 shows an emulation apparatus for driving according to the invention.

In the present document, the measurements, values, shapes and geometric references (such as perpendicularity and parallelism), when associated with words like “about” or other similar terms such as “approximately” or “substantially”, are to be considered as except for measurement errors or inaccuracies due to production and/or manufacturing errors, and, above all, except for a slight divergence from the value, measurements, shape, or geometric reference with which it is associated. For instance, these terms, if associated with a value, preferably indicate a divergence of not more than 10% of the value.

Moreover, when used, terms such as “first”, “second”, “higher”, “lower”, “main” and “secondary” do not necessarily identify an order, a priority of relationship or a relative position, but can simply be used to clearly distinguish between their different components.

Unless otherwise specified, as results in the following discussions, terms such as “treatment”, “computing”, “determination”, “calculation”, or similar, refer to the action and/or processes of a computer or similar electronic calculation device that manipulates and/or transforms data represented as physical, such as electronic quantities of registers of a computer system and/or memories in, other data similarly represented as physical quantities within computer systems, registers or other storage, transmission or information displaying devices.

The measurements and data reported in this text are to be considered, unless otherwise indicated, as performed in the International Standard Atmosphere ICAO (ISO 2533:1975).

With reference to the Figures, the emulation apparatus according to the invention is globally indicated with the number 1.

It is capable of allowing a practitioner to emulate the driving of an experienced driver.

Said driver therefore preferably drives a vehicle 5, such as an aircraft, military or civilian, or an automobile or even more. Vehicle 5 can also be a sports vehicle, such as a formula 1 car or similar.

The vehicle 5 comprises control device 50, known per se, such as joystick, steering wheel, pedals, levers and switches and even more.

The apparatus 1 preferably comprises shooting device 20 configured to capture the view of the driver of the vehicle 5 and generate a shooting output. They are preferably one or more cameras showing, for example, the view or part of the view given by the main window on the vehicle 5, the driver's helmet or other (FIG. 1).

The apparatus 1 also preferably comprises sensor device 21 configured to check the instantaneous conditions of the vehicle 5 and generate a condition output of the vehicle 5.

The sensor device 21 preferably comprise accelerometers, and/or one or more of gyroscopes, telemetry, inertial platforms, and similar, connected to the vehicle 5 and able to determine its condition.

Alternatively, or in addition, the sensor device 21 are directly connected to the control device 50 of the vehicle 5, and therefore directly detect the movement of the steering wheel and similar.

Alternatively, or in addition, the sensor device 21 obtain information indirectly through the images of the recording device.

The apparatus 1 also preferably comprises a control apparatus 22. The control apparatus 22 is a heterogeneous system and generally comprises a server computer, per se known, and preferably connected devices suitable for controlling the process described.

The control apparatus 22 preferably comprising transmission device 23, configured to receive the shooting output and the condition output, respectively from the shooting device 20 and the sensor device 21. Said transmission device 23 are preferably antennas or cards and/or cables, or wireless connections, bluetooth and radio for internet connection. Logically also the sensor device 21 and the shooting device 20 are preferably connected to the Internet via suitable connection device.

The emulation apparatus 1 further comprises at least one emulation device 3, used by the practitioner. There may also be more emulation devices 3 used simultaneously by a plurality of practitioners.

The emulation device 3 comprises connection device with the control apparatus 22, such as web connections known per se.

The emulation device 3 preferably comprises display device 30, such as a screen or similar, suitable for displaying the output of said shooting device 20. The practitioner can therefore see what the driver sees, or something very similar.

The emulation device 3 also preferably comprises control device 31 configured to emulate the control device 50 of the vehicle 5, so as to allow the practitioner to emulate the driving of the vehicle 5, the control device 31 therefore generate a practicing control output.

The control device 31 can be constituted by joysticks and steering wheels, for example similar to those used for video games and similar to the control device 50 of the vehicle 5 or even more. The device 3 can also comprise, or be, a simple smartphone or tablet, which therefore already comprises the display device 30 and the connection device. In this case the control device 31 can be given by the inclination of the smartphone and the accelerometers connected.

Advantageously, the control apparatus 22 compares the condition output of the vehicle 5 with the operating control output and displays on the display device 30 a comparison between said outputs (FIG. 1). Basically, the practitioner visualizes, for example, the degrees of turn of an aircraft and the video of the turn, preferably substantially live, and at the same time visualizes the difference with his own turn, for example with a second visual signal 25, given by the reactions on the commands that realized.

Preferably, the transmission device 23 transmit the shooting output and the condition output substantially in real time, or live, and display the comparison between the outputs substantially in real time.

Alternatively, especially if there are several practitioners who can also directly compare each other, the control apparatus 22 is configured to determine a delay in the transmission of the output to allow the simultaneous transmission of the outputs. In such a way as to allow even the slowest connections or devices to connect and act with simulation.

The operation of the emulation apparatus 1 previously described in structural terms is as follows.

It also defines a new emulation procedure for driving of a vehicle 5 preferably made with the emulation apparatus 1 described above.

The emulation process preferably comprises:
the driving of the vehicle 5 by a driver,
the shooting of the view of the driver of the vehicle 5, preferably by means of the shooting device and the described methods, and the generation of a shooting output,
the verifying, by means of sensor device 21, preferably of the type described above, of the instantaneous conditions of the vehicle 5 and the generation of an output condition,
the transmission of shooting output and condition output of a control apparatus 22, preferably of the type described and preferably by means of the transmission device described,
the connection of at least one emulation device 3, or of more emulation devices 3, preferably of the type described, to the control apparatus 22,
the display of the shooting output on the emulation device 3,
the generation of a practising control output by means of command device 31 activated by the practitioner,
the comparison of the condition output of the vehicle 5 with the practicing control output and the display on the display device 30 of the comparison between the outputs. This comparison and display preferably takes place in real time or with a predetermined delay as previously described.

The emulation apparatus 1 according to the invention achieves important advantages.

Indeed, it allows a practitioner to emulate an experienced driver in real time and with precision.

The practitioner, therefore, is not in front of a simulator, but in real conditions, and can accurately verify the differences between his driving and the guide of the expert driver, without however taking any risks, including physical ones for the driver and the surrounding people, and in the problems that would have a real guide.

Moreover, the said emulator is simple and inexpensive.

The invention is susceptible of variants falling within the scope of the inventive concept defined by the claims.

For example, a concrete embodiment of this procedure can be an application or software for smartTV or similar, which is operationally similar to a broadcasting channel with an emulation filter of the film shown. The control (joystick, steering wheel, joystick, or smartphone) could therefore be connected either via cable or wireless.

For example, the procedure can be extended to the use of other objects, not only driving vehicles or even the movement of an expert without objects or means.

1. An emulation apparatus (1) for driving a vehicle (5) driven by a driver and comprising a control device (50), said emulation apparatus (1) comprising:
a shooting device (20) to film the view of said driver of said vehicle (5) and generate a shooting output,
a sensor device (21) to check the instantaneous conditions of said vehicle (5) and generate a condition output,
a control apparatus (22) comprising a transmission device (23) to receive said recovery output and said condition output,
said emulation apparatus (1) comprising: at least one emulation device (3) at distance of said vehicle, capable of connecting said control apparatus (22) and comprising:
a display device (30) of said shooting output,
a control device (31) configured to emulate said control device (50) of said vehicle (5), so as to allow a practitioner to emulating said guide of said vehicle (5), said control device (31) by generating a practicing control output,
said control apparatus (22) by comparing said condition output of said vehicle (5) with said practicing control output and displaying on said display device (30) a comparison between said outputs.

2. The emulation apparatus (1) according to claim 1, wherein said transmission device (23) transmit said shooting output and said condition output substantially in real time, and display said comparison between said output substantially in real time.

3. The emulation apparatus (1) according to claim 1, wherein said control apparatus (22) determines a delay of said transmission of said output to allow the simultaneous transmission of said output.

4. The emulation apparatus (1) according to claim 1, wherein a plurality of emulation devices (3) are present for a plurality of practitioners.

5. The emulation apparatus (1) according to claim 1, wherein said sensor device (21) comprise accelerometers connected to said vehicle.

6. The emulation apparatus (1) according to claim 1, wherein said sensor device (21) are directly connected to said control device (50) of said vehicle (5).

7. A procedure of emulation of driving a vehicle (5) comprising a control device (50), said procedure of emulation (1) comprising:
driving of said vehicle (5) by a driver,
shooting of the view of said driver of said vehicle (5) and the generation of a shooting output,
the verification, by a sensor device (21) of the instant conditions of said vehicle (5) and the generation of a condition output,
the transmission of said shooting output and said condition output to a control apparatus (22),
said procedure of emulation (1) comprising:
the connection at a distance of at least one emulation device (3) to said control apparatus (22),
said emulation device (3) comprising a display device (30) and a control device (31) configured to emulate said control device (50) of said vehicle (5),
said procedure further comprising:
the display of said shooting output on said emulation device (3),
the generation of a control output practicing through said control device (31),
the comparison of said condition output of said vehicle (5) with said control output practicing and the display on said display device (30) of a comparison between said outputs.

8. The procedure of emulation according to claim 7 wherein said transmission and said comparison of said shooting output and said condition output is substantially in real time.

9. The procedure of emulation according to claim 7, wherein said transmission and said comparison of said shooting output and said condition output takes place with a determined delay to allow the simultaneous transmission of said outputs.

10. The procedure of emulation according to claim 7, wherein a plurality of emulation devices (3) are present for a plurality of practitioners.
